(19) United States
(12) Patent Application Publication
(10) Pub. No.: US 2014/0058768 A1
(43) Pub. Date: Feb. 27, 2014

(54) SYSTEM AND METHOD FOR TRIP PLANNING SUGGESTIONS

(71) Applicant: Google Inc., Mountain View, CA (US)

(72) Inventors: Emily Moxley, San Francisco, CA (US); Sean Liu, Sunnyvale, CA (US)

(73) Assignee: Google Inc., Mountain View, CA (US)

(21) Appl. No.: 13/972,094

(22) Filed: Aug. 21, 2013

Related U.S. Application Data
(60) Provisional application No. 61/691,516, filed on Aug. 21, 2012.

(51) Int. Cl. G06Q 10/02

(52) U.S. Cl. CPC G06Q 10/02
USPC 705/5

(57) ABSTRACT

A trip destination for an individual may be determined. A set of contacts associated with the individual and the trip destination may be identified. A meeting location associated with the trip destination and one or more of the individual and a member of the set of contacts may be identified. A free time slot associated with the individual or a member of the set of contacts may be identified. A suggested calendar appointment associated with the individual, the free time slot, the location, and one or more members of the set of contacts may be provided.

### CROSS-REFERENCE TO RELATED APPLICATION

This application claims the benefit of U.S. provisional patent application Ser. No. 61/691,516, filed on Aug. 21, 2012, entitled “System and Method for Trip Planning suggestions,” the entire disclosure of which in incorporated herein by reference.

### TECHNICAL FIELD

This disclosure relates to providing trip planning suggestions related to locations, sets of contacts, events and event timing.

### BACKGROUND

For business, personal and other reasons, individuals often travel from their home (or other) locations to different destinations. Such trips may present opportunities to visit various neighborhoods, businesses, and other locations at or near the destination. Such trips may also present opportunities to meet with one or more contacts that may reside in or near (or be temporarily located in or near) the destination. When traveling, despite the desire to visit various locations and/or meet with various contacts, individuals may experience calendar-related constraints such as limited segments of free time.

### SUMMARY OF DISCLOSURE

In one implementation, a method may include determining, by one more computing devices, a trip destination for an individual. The method may further include identifying, by the one or more computing devices, a set of contacts associated with the individual and the trip destination. The method may also include identifying, by the one or more computing devices, a meeting location associated with the trip destination and one or more of the individual and a member of the set of contacts. The method may additionally include identifying, by the one or more computing devices, a free time slot associated with one or more of the individual and a member of the set of contacts. The method may also include providing, by the one or more computing devices, a suggested calendar appointment associated with the individual, the free time slot, the location, and one or more members of the set of contacts.

One or more of the following features may be included. In some embodiments, the method may include determining that an individual is taking a trip by comparing information associated with one or more of a current and a planned location of the individual with information associated with a home location of the individual. The method may include determining one or more of a current, planned and home location by analyzing one or more of social network information, application information, historical location information, check-in information, calendar information, and message content information. The method may identify one or more of the set of contacts and a member of the set of contacts by analyzing one or more of social network information, application information, calendar information, message information, and check-in information. The method may analyze social network information by identifying common social networking group names. The method may analyze message information by performing statistical analysis of message frequency.

The method may identify a meeting location by determining a set of preferred locations based on analysis of one or more of past behavior, social network information, message information, calendar information, user input information, current-location information, profile information, and check-in information. The method may identify a meeting location based upon information associated with one or more of the individual and a member of the set of contacts.

The method may identify a free time slot by analyzing calendar information. The calendar information may be associated with one or more of the individual and a member of the set of contacts.

In another implementation, a computer program product includes a computer readable medium having a plurality of instructions stored on it. When executed by a processor, the instructions may cause the processor to perform operations including determining a trip destination for an individual. Instructions may further be included for identifying a set of contacts associated with the individual and the trip destination. Instructions may also be included for identifying a meeting location associated with the trip destination and one or more of the individual and a member of the set of contacts. Instructions may also be included for identifying a free time slot associated with one or more of the individual and a member of the set of contacts. The computer program product may further include instructions for providing a suggested calendar appointment associated with the individual, the free time slot, the location, and one or more members of the set of contacts.

One or more of the following features may be included. In some embodiments, instructions may be included for determining that an individual is taking a trip by comparing information associated with one or more of a current and a planned location of the individual with information associated with a home location of the individual. Instructions may be included for determining one or more of a current, planned and home location by analyzing one or more of social network information, application information, historical location information, check-in information, calendar information, and message content information. Instructions may also be included to identify one or more of the set of contacts and a member of the set of contacts by analyzing one or more of social network information, application information, calendar information, message information, and check-in information. Instructions may also be included to analyze social network information by identifying common social networking group names. Instructions may be included to analyze message information by performing statistical analysis of message frequency.

The instructions for identifying a meeting location may include instructions for determining a set of preferred locations based on analysis of one or more of past behavior, social network information, message information, calendar information, user input information, current-location information, profile information, and check-in information. Instructions may be included to identify a meeting location based upon information associated with one or more of the individual and a member of the set of contacts.

Instructions may be included to identify a free time slot by analyzing calendar information. The calendar information may be associated with one or more of the individual and a member of the set of contacts.

In another implementation, a computing system is provided. In some embodiments, the computing system may include one or more processors configured to determine a trip destination for an individual. The one or more processors may be further configured to identify a location associated with the trip destination and one or more of the individual and a member of the set of contacts. The one or more processors may be further configured to identify a free time slot associated with the individual. The one or more processors may be further configured to provide a suggested calendar appointment associated with the individual, the free time slot, the location, and one or more members of the set of contacts.

In some embodiments, the one or more processors may be further configured to determine that an individual is taking a trip by comparing information associated with one or more of a current and a planned location of the individual with information associated with a home location of the individual. The one or more processors may be further configured to determine one or more of a current, planned and home location by analyzing one or more of social network information, application information, historical location information, check-in information, calendar information, and message content information. The one or more processors may be further configured to identify one or more of the set of contacts and a member of the set of contacts by analyzing one or more of social network information, application information, calendar information, message information, and check-in information. The one or more processors may be further configured to analyze social network information by identifying common social networking group names. The one or more processors may be further configured to analyze message information by performing statistical analysis of message frequency.

The one or more processors may be further configured to identify a meeting location by determining a set of preferred locations based on analysis of one or more of past behavior, social network information, message information, calendar information, user input information, current-location information, profile information, and check-in information. The one or more processors may be further configured to identify a meeting location based upon information associated with one or more of the individual and a member of the set of contacts.

The one or more processors may be further configured to identify a free time slot by analyzing calendar information. The calendar information may be associated with one or more of the individual and a member of the set of contacts.

The details of one or more implementations are set forth in the accompanying drawings and the description below. Other features and advantages will be apparent from the description and the drawings.

### BRIEF DESCRIPTION OF THE DRAWINGS

FIG. 1 is a diagrammatic view of a trip planning suggestion process associated with a computing network in accordance with an example embodiment of the present disclosure;

FIG. 2 is a flowchart of the trip planning suggestion process of FIG. 1 in accordance with an example embodiment of the present disclosure;

FIG. 3 is a flowchart of the trip planning suggestion process of FIG. 1 in accordance with an example embodiment of the present disclosure; and

FIG. 4 is a diagrammatic view of a computing device that may implement the trip planning suggestion process of FIG. 1 in accordance with an example embodiment of the present disclosure.

Like reference symbols in the various drawings may indicate like elements.

### DETAILED DESCRIPTION OF THE EMBODIMENTS

Some embodiments of a trip planning suggestion (“TPS”) process disclosed herein may include techniques for automatically providing suggestions of contacts with which an individual may wish to meet during a trip to a particular destination (e.g., a particular city) and may further automatically provide suggestions of meeting locations and times for those meetings. In this way, the TPS process described herein may intelligently facilitate meetings between an individual and one or more contacts.

Accordingly, an example embodiment may include a system and method for identifying a trip destination for an individual, identifying a set of contacts associated with the individual, identifying a location associated with the trip destination, identifying a free time slot associated with one or more of the individual and a member of the set of contacts, and providing a suggested calendar appointment (e.g., via a message window viewable via a mobile phone/computing device) associated with the free time slot, the identified location, the individual and a member of the set of contacts.

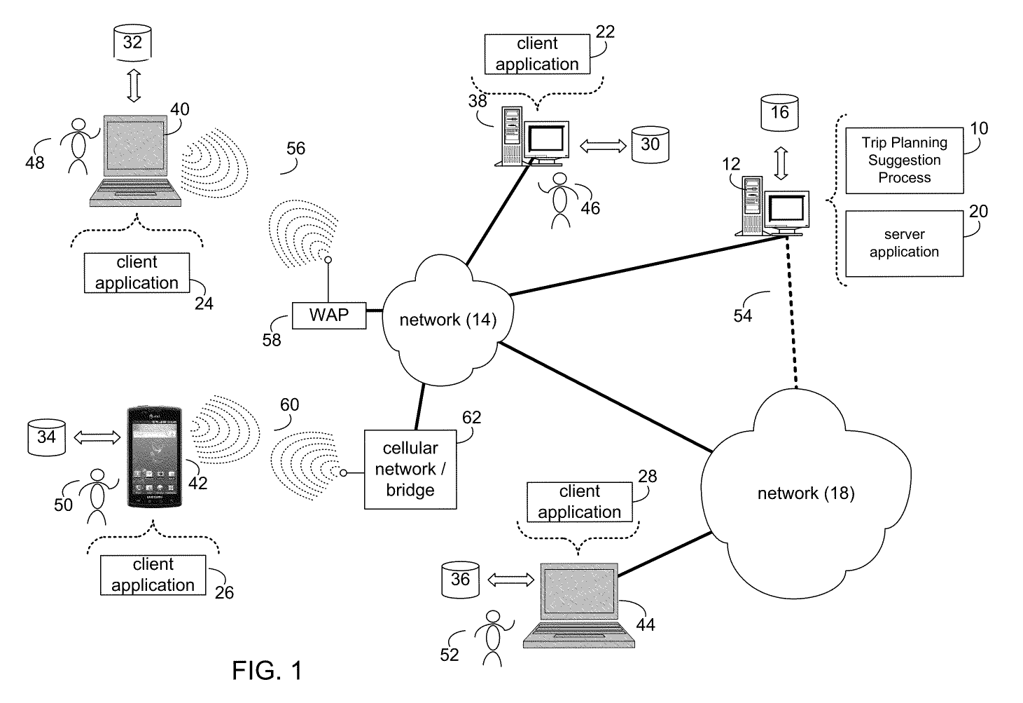

Referring to FIG. 1, there is shown a TPS process 10 that may reside on and may be executed by computer 12, which may be connected to network 14 (e.g., the Internet or a local area network). Server application 20 may include some or all of the elements of TPS process 10 described herein. Examples of computer 12 may include but are not limited to a single server computer, a series of server computers, a single personal computer, a series of personal computers, a mini computer, a mainframe computer, an electronic mail server, a social network server, a text message server, a photo server, or a computing cloud. The various components of computer 12 may execute one or more operating systems, as are known in the art.

The instruction sets and subroutines of TPS process 10, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

TPS process 10 may operate as a standalone application or alternatively as a component, a module, an applet or plug-in operating within a separate program such as server application 20 and may be accessed via client applications 22, 24, 26, 28. Examples of client applications 22, 24, 26, 28 may include, but are not limited to a standard web browser, a customized web browser, or a custom application. The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, notebook computer 44, a server (not shown), a data-enabled, cellular telephone (not shown), a television with one or more processors embedded therein or coupled thereto, and a dedicated network device (not shown).

It will be understood that although TPS process 10 is mainly discussed herein a sever-side process, the TPS process may also operate as a client process operating as a standalone client application (not shown) or alternatively as a module, a component, an applet or plug-in operating within a separate program such as client application 22, 24, 26, or 28.

As noted above, one or more of client applications 22, 24, 26, 28 may be configured to effectuate some or all of the functionality of TPS process 10. Accordingly, TPS process 10 may be a purely server-side application, a purely client-side application, or a hybrid server-side/client-side application that is cooperatively executed by one or more of client applications 22, 24, 26, 28 and TPS process 10.

Users 46, 48, 50, 52 may access computer 12 and TPS process 10 directly through network 14 or through secondary network 18. Further, computer 12 may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Smart phone 42 is shown wirelessly coupled to network 14 via wireless communication channel 60 established between smart phone 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and smart phones to be interconnected using a short-range wireless connection. Client electronic devices 38, 40, 42, 44 may each execute an operating system, as are known in the art.

A number of users 46, 48, 50, and 52 of the client devices 38, 40, 42, 44, respectively, may access server computer 12 (or another device) to participate in a social networking service provided by server application 20, or another server (or client) application (not shown). For example, the client devices 38, 40, 42, 44 can execute web browser applications that can be used to access the social networking service. In another example, the client devices 38, 40, 42, 44 may execute software applications that may be specific to the social network (e.g., social networking “apps” running on smartphones).

The users 46, 48, 50, and 52 may participate in the social networking service provided by server computer 12 by posting information, such as text comments (e.g., updates, announcements, replies), digital photos, videos, or other appropriate electronic information. In some implementations, information can be posted on a user's behalf by systems and/or services external to the social network or the server computer 12. In another example, a software application executing on a mobile device, with proper permissions, may use global positioning system (GPS) or other capabilities to determine the user's location and automatically update the social network with his location (e.g., “At Home”, “At Work”, etc.).

As discussed above, one or more of users 46, 48, 50, 52 may access server computer 12 and TPS process 10 through network 14 or secondary network 18. For example, and for illustrative purposes only, assume that user 50 (i.e., the user of mobile computing device 42) wishes to use TPS process 10. User 50 may access TPS process 10 through client application 26 associated with mobile computing device 42. In this way, TPS process 10 may operate as a standalone application or alternatively as a module, a component, an applet or plug-in operating within a separate program such as server application 20. In some embodiments, server application 20 may include a social networking application/social networking service. Although, this particular example focuses upon user 50 and mobile computing device 42 it should be noted that this disclosure is not meant to be limited to this particular example as personal computer 38, laptop computer 40, smart phone 42, notebook computer 44, etc., may also be used to access and/or render some or all of the embodiments of TPS process 10 described herein.

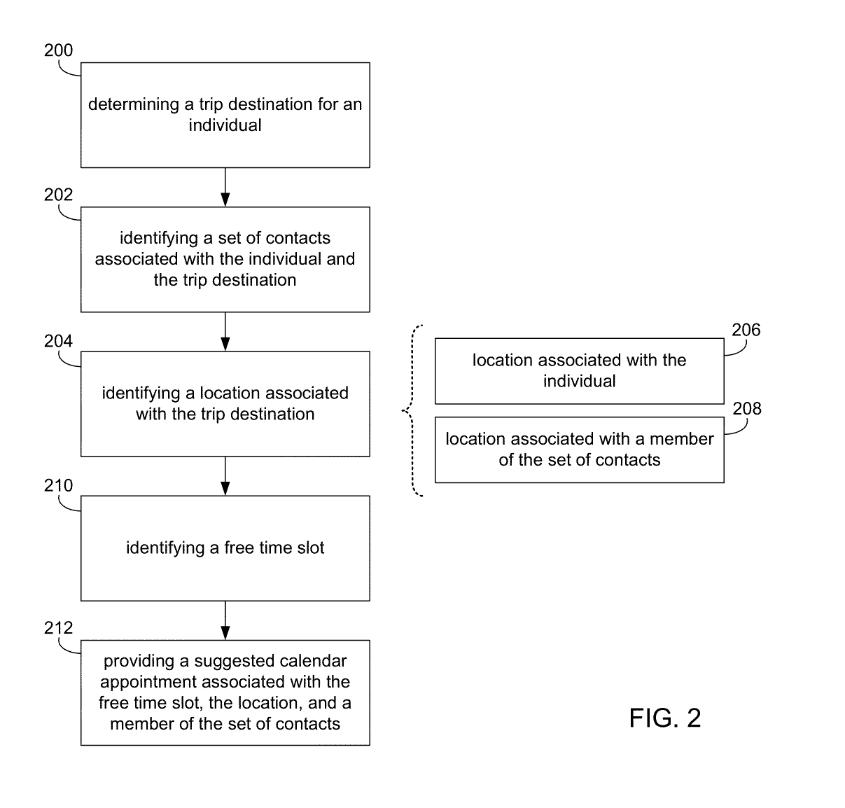

As discussed above and referring now also to FIG. 2, TPS process 10 may determine 200 a trip destination for an individual. For a variety of reasons, individuals may sometimes travel from a home location to a destination location. For example, an individual may live and/or work in Tucson, Ariz. and may occasionally travel to Melbourne, Australia for work and to Augusta, Me. for vacation. For such an individual, TPS process 10 may determine 200 a trip destination, respectively, of Melbourne and Augusta. It will be understood that a trip destination need not be located a particular distance away from a home destination. For example, an individual who typically telecommutes from a suburban residence may occasionally travel into a nearby city center for a series of in-person meetings. In such a case, TPS process 10 may determine 200 a trip destination of the city center for that individual.

TPS process 10 may also identify 202 a set of contacts associated with the individual and the trip destination. While at the trip destination, it may be desirable for the traveling individual to meet with one or more contacts, potentially including friends, family, co-workers, business associates, networking contacts, and so on who may be associated with the trip destination (e.g., who may reside at or near the trip destination, and/or who may plan to be at or near the trip destination during the time of the individual's trip). Accordingly, TPS process 10 may identify 202 one or more such individuals as contacts with whom a meeting for the individual may be possible. It will be understood that in some embodiments, TPS process 10 may identify 202 multiple sets of contacts. For example, TPS process 10 may identify a first set of business contacts related to a particular business project or opportunity the individual is involved with or interest in. TPS process 10 may also identify a second set of contacts including past college roommates of the individual, a third set of contacts including former members of a championship softball team the individual played for, a fourth set of contacts including family members and close personal friends of the individual, and so on. In this way, TPS process 10 may identify 202 various sets of contacts relating to various types of desirable meetings. However, in other embodiments, TPS process 10 may not classify and/or group contacts into various sets and/or categories. In some such embodiments, TPS process 10 may identify all contacts associated with the individual and the trip destination as a single set of contacts.

As noted above, the contacts may be associated with the trip destination. For example, it may be useful to identify a set of relevant contacts that will be located at or near the trip destination at the same time as the individual in order to facilitate scheduling a meeting between the individual and one or more of the contacts during the individual's trip. Accordingly, TPS process 10 may identify 202, for example, a set of contacts including contacts that live or work in or near the trip destination or a set of contacts including contacts that will be present at or near the trip destination during the individual's trip (e.g., because those contacts are also traveling to the same destination during overlapping times).

TPS process 10 may also identify 204 a meeting location associated with the trip destination. In order to facilitate a meeting between the individual and one or more members of the identified 202 set of contacts, it may be useful for TPS process 10 to identify 204 a potential meeting location that is in or near the trip destination. For example, TPS process 10 may identify 204 a restaurant at which the individual and one or more members of a particular set of contacts might meet for dinner, a park at which the individual and a set of friends might meet for an afternoon of relaxation, a store at which the individual and one or more acquaintances might meet to shop and chat, and so on. Continuing the examples above, TPS process 10 may identify, for example, based on the trip destination of the individual, a restaurant in Melbourne, a mini-golf course in Augusta, or a shopping mall or wooded park area in the city center.

It will be understood that a meeting location may include a variety of location types, including a location at which the individual and one or more contacts may spend time together, or a location at which the individual and one or more contacts may meet before proceeding to a different location. As noted above, a meeting location may include, for example, a restaurant, store, or park. Alternatively, for example, a meeting location may include a museum, a particular intersection (e.g., the corner of Broadway and 52nd St.), a location of historical or other interest (e.g., a historical marker or landmark site), and so on. It will be further understood that a meeting location may be a specific location (e.g., 99 St. Bartholomew Ave.) or may be a more generalized location (e.g., Central Park) or neighborhood (e.g., the North End near the Rose Kennedy Greenway).

Because the number of potential meeting locations associated with a trip destination may be large, it may also be useful for TPS process 10 to identify 204 a meeting location 206 that is associated with the individual. For example, TPS process 10 may identify 204 a particular restaurant that is a favorite restaurant of the individual or serves a type of food enjoyed by the individual. As another example, TPS process 10 may identify a park that is nearby the location where the individual will be working while at the trip destination or a shop that is nearby the location where the individual will be staying while at the trip destination (e.g., a hotel or friend's residence). Alternatively, TPS process 10 may identify 204 a location that is easily accessible for the individual via mass transit or other transportation options. For example, TPS process 10 may identify 204 a restaurant located near a particular subway line, where the subway line also has a station nearby the location where the individual will be working or staying while at the trip destination. In this way, TPS process 10 may identify 204 a potential meeting location that will be convenient and/or desirable for the traveling individual.

TPS process 10 may also identify 204 a meeting location 208 associated with a member of the set of contacts. As also noted above, the number of potential meeting locations associated with a trip destination may be large. Accordingly, it may be useful for TPS process 10 to identify 204 a meeting location 208 that is associated with a member of the set of contacts. For example, TPS process 10 may identify 204 a particular restaurant that is a favorite restaurant of a member of the set of contacts or serves a type of food enjoyed by a member of the set of contacts. As another example, TPS process 10 may identify a park or a shop that is nearby the location where a member of the set of contacts works, lives or otherwise frequents. Alternatively, TPS process 10 may identify 204 a location that is easily accessible for a member of the set of contacts via mass transit or other transportation options. For example, TPS process 10 may identify 204 a restaurant located near a particular subway line, where the subway line also has a station nearby a location where a member of the set of contacts works, lives or otherwise frequents. TPS process 10 may identify 204 a location automatically, based on a user input (e.g., from the individual and/or a member of the set of contacts), or both. In certain embodiments, TPS process 10 may identify 204 a location by specifying a location placeholder such as an indication that the location is “to be determined” (commonly denoted “TBD”).

TPS process 10 may also identify 210 a free time slot, which may be associated with the individual, a member of the set of contacts, or both. In order to facilitate a meeting between the individual and a member of the set of identified contacts, it may be desirable to identify 210 a particular time during which to schedule the meeting. In this way, both the individual and the member of the set of contacts can keep the particular time free from other appointments, plan for transit time to reach the meeting location and return from it, and so on. Accordingly, TPS process 10 may receive calendar and other information relating to the individual and/or the member of the set of contacts in order to identify 210 block of time during which the individual and/or the member of the set of contacts is available. TPS process 10 may identify 210 a free time slot automatically, based on a user input (e.g., from the individual and/or a member of the set of contacts), or both. In certain embodiments, TPS process 10 may identify 210 a free time slot by specifying a time slot placeholder such as an indication that the time is “to be determined” (commonly denoted “TBD”).

It will be understood that in some embodiments, identifying 210 a free time slot may include identifying a time slot during which one or more of the individual and the member of the set of contacts have already scheduled a different appointment. For example, it may be determined that the individual may have a strong desire to meet a close friend for dinner, while at the trip destination, and that the close friend is only available on Saturday night from 7 PM to 9 PM. However, it may also be determined that the individual has a different appointment already scheduled for that time period. Based on the determination that the dinner meeting with the friend may be a high priority for the individual, TPS process 10 may identify 210 7 PM to 9 PM on Saturday night as a free time slot for the individual despite the pre-existing appointment. In such a case, TPS process 10 may, for example, also identify 210 a different time interval to which the pre-existing appointment may be moved in order to allow the individual to meet with the friend and still participate in the pre-existing appointment.

TPS process 10 may also provide 212 a suggested calendar appointment associated with the individual, the free time slot, the location and one or more members of the set of contacts. Having determined 200 a trip destination, identified 202 a set of contacts, identified 204 a meeting location, and identified 210 a free time slot, TPS process 10 may have received sufficient information to provide 212 a suggested appointment. For example, continuing the examples above, TPS process 10 may have identified 200 a trip destination of Melbourne, identified 202 a set of business contacts who live and/or work in or near Melbourne and/or will be in or near Melbourne during the trip, identified 204 a popular seafood restaurant in Melbourne that is likely to be enjoyed by the individual and the set of business contacts while also providing an appropriate atmosphere to discuss a business opportunity (based, for example, on reviews of the restaurant available through internet resources), and identified 210 a time interval during which the individual and the business contacts are available for a dinner meeting. Accordingly, TPS process 10 may provide 212 a suggested calendar appointment for a dinner meeting between the individual and the business contacts at the Melbourne seafood restaurant during the identified time interval.

In one embodiment, TPS process 10 may provide 212 the suggested appointment to the individual. For example, TPS process 10 may cause a pop-up notification to appear on the individual's phone or computing device including the details of the proposed meeting. In this embodiment, the notification may include, for example, functionality (e.g., a rendered “action button”) allowing the individual to accept the suggestion, edit the suggestion, send to the contacts an invitation to the meeting, and place the meeting on the individual's calendar. Alternatively, in response, for example, to an input of scheduling preferences by the individual, TPS process 10 may automatically provide 212 the suggested appointment to the contacts, rather than waiting for approval of the appointment by the individual.

It will be understood that the various functionality discussed herein may implemented in a variety of ways and with a variety of timing. For example, in one embodiment, TPS process 10 may operate upon request of the individual. For example, the individual may activate an application embodying TPS process 10 on her smart phone in order to proactively schedule various meetings for a particular future trip. In another embodiment, TPS process 10 may operate automatically upon an individual scheduling a trip, upon an individual's arrival at a trip destination or at some intermediate time (e.g., three days before the scheduled start of the trip). Alternatively, for example, TPS process 10 may operate during a trip in response to a detected new availability of the individual, a location, a time slot, and/or a member of a set of contacts. For example, if a previously-scheduled business meeting during a trip is cancelled, TPS process 10 may determine that the traveling individual now has additional free time at the trip destination and may accordingly desire to meet with other business contacts, or with family or friends who live in or near the trip destination. As such, TPS process 10 may then operate in order to provide a suggested new meeting to replace the now-cancelled meeting. As another example, TPS may identify 202 a contact who has newly arrived at the trip destination and may suggest 212 adding the newly-arrived contact to a previously suggested and/or scheduled appointment.

It will also be understood that TPS process 10 may allow for editing of a suggested calendar appointment by one or more of the individual and one or more members of the set of contacts included in the calendar appointment. For example, an individual (or contact) may desire to extend (or shorten) the scheduled time of the appointment, may desire to change the location of the meeting, or may desire to add (or delete) certain contacts to (or from) the appointment. Accordingly, for example, a pop-up notification may include action buttons allowing an individual (or contact) to access and edit one or more details of the suggested appointment.

Providing 212 a suggested calendar appointment may be based on various hierarchies of constraints and be based on operations that occur in various orders. For example, in one hierarchy, TPS process 10 may first analyze the set of contacts to determine which of the contacts to schedule a meeting with, then identify 210 a time slot, then identify 204 a location. In one embodiment, for example, TPS process 10 may determine that a trip is a vacation and therefore that priority should be given to non-business contacts when identifying 202 a set of contacts. In another embodiment, TPS process 10 may alternatively determine that a trip is related to a particular business project and therefore that priority should be given to business contacts also associated with that project. Continuing this example, once TPS process 10 has identified 202 a set of contacts, time constraints may impose greater restrictions on scheduling that do location constraints. For example, in a city with extensive transportation networks, reaching a wide variety of possible meeting locations may be relatively easy and require relatively little travel time, but the number of overlapping free time intervals among the desired meeting participants may be limited. Accordingly, TPS process may next identify 210 available times for the individual and the relevant contacts. Then, having identified 202 contacts and 210 an appropriate time slot, TPS process 10 may identify 204 an appropriate location. For example, if the identified time slot is early in the morning and a meeting over a meal is desired, TPS process 10 may identify 204 an all-you-can-eat pancake buffet rather than a sushi bar. Alternatively, if the identified time slot is late in the evening and the meeting is among social contacts rather than business-related contacts, TPS process may identify 204, for example, a salsa dance club rather than a hotel lobby or conference room.

As another example, if the meeting will be scheduled for two hours (e.g., as determined by analysis of the context of the meeting), but the overlapping free time of the contacts includes only two hours and fifteen minutes, TPS process 10 may identify 204 a location that is nearby the individual and the contacts in order to avoid losing valuable meeting time due to the required travel to the meeting location.

In another embodiment, once a meeting time has been identified 210, TPS process 204 may identify 206 a set of locations where an individual is likely to be during the identified time as well as 208 a set of locations the contacts are likely to be during the identified time and identify 204 a meeting location based on the intersection of those sets of locations. For example, if a meeting is scheduled for Boston at 8 PM on Saturday, TPS process 10 may determine that the individual tends to be near the North End around that time, and may determine that most of the contacts tend to be near the Boston Common around that time. TPS process 10 may therefore identify 204 a meeting location halfway between the two—e.g., a restaurant nearby the Haymarket subway station.

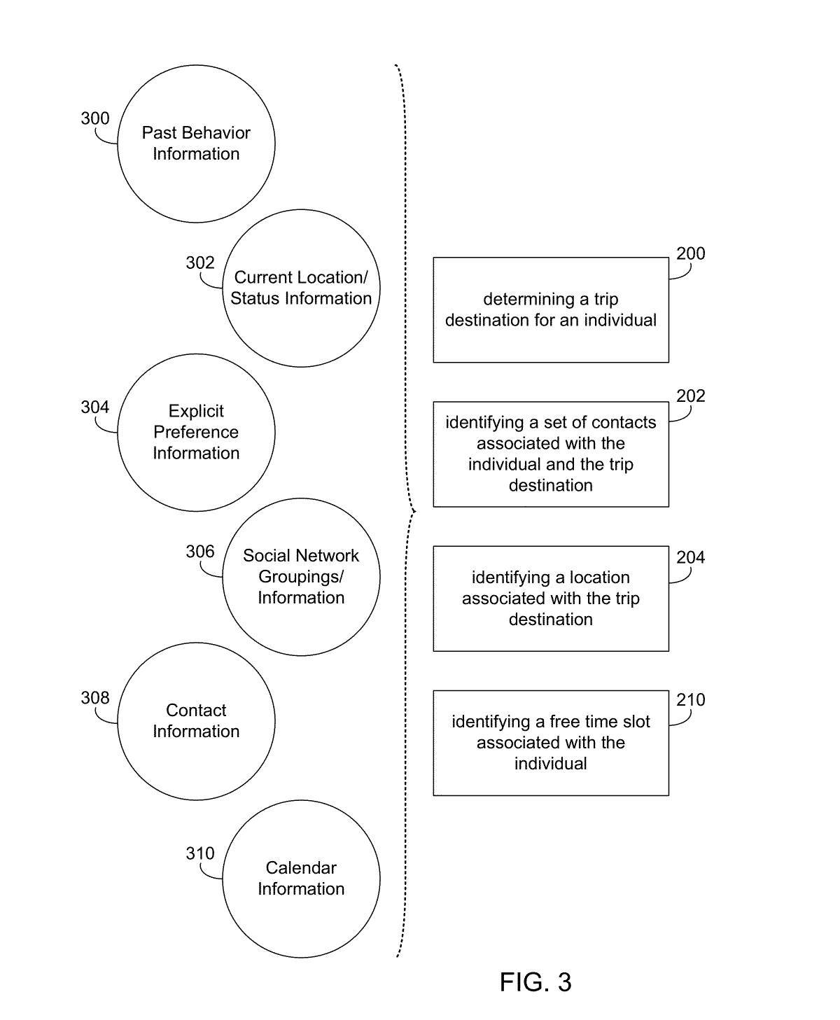

Referring now also to FIG. 3, one or more of determining 200 a trip destination, identifying 202 a set of contacts, identifying 204 a meeting location, and/or identifying 210 a free time slot may be based on a variety of information. For example, past behavior information 300 may provide useful information regarding trip destinations, contacts with whom meetings may be desirable, locations at which meetings may be appropriate, time slots during which meetings at particular locations and/or with particular contacts may be preferred, and so on, various operations of TPS process 10 may be based upon past behavior information 300.

Generally, TPS process 10 may determine or receive past behavior information related to trip destination or meeting location from a variety of sources. For example, with respect to locations, TPS process 10 may analyze (or otherwise receive) information relating to the location of an individual or contact based on various location services. For example, data from a location services application can provide historic location information (i.e., the locations an individual or contact has been in the past). It will be understood that location information based on past behavior (or based on other sources) may be determined with various levels of granularity. For example, location information may relate to specific locations like restaurants, etc. or may relate to more general information like neighborhoods, etc. In some embodiments, information recorded by location services applications may be stored by the location services application and may be accessed by TPS process 10. In some embodiments, information recorded and/or identified by location services application may be stored by another application, such as a social networking application. In such an embodiment, TPS process 10 may access the information from the social networking application.

In one embodiment, location information from various sources may be statistically analyzed in order to determine useful information. For example, TPS process 10 may determine 200 a trip destination or identify 204 a location based on statistical analysis of past location information. For example, determining the mathematical mode of location information for an individual or contact may serve to identify the home location of the individual or contact, which information may be combined with other location information to determine that an individual is on a trip (i.e., away from home) and thereby to determine 200 a trip destination. Additionally, statistical analysis of past location information may yield information regarding, for example, commonly visited (and therefore, potentially, preferred) meeting locations such as favorite restaurants or parks, and so on.

In another embodiment, identifying 202 a set of contacts may be based on, at least in part, past behavior information 300. For example, TPS process 10 may analyze (or otherwise receive) information relating to past communication between the individual and possible contacts. For example, TPS process may determine a set of contacts with whom the individual frequently emails, instant messages, text messages, calls using VoIP applications, and so on, and thereby identify 202 that set of contacts as including important friends, family, business associates, and so on. Such analysis may further include, for example, identifying, as part of an affinity score, contacts who are followed by the individual via internet-based resources such as RSS feeds or social networks like the Twitter® service, the Facebook® service, the Google+™ social service, and so on. (Twitter is a registered trademark of Twitter, Inc. in the United States and/or other countries. Facebook is a registered trademark of Facebook, Inc. in the United States and/or other countries. Google+ is a trademark of Google, Inc. in the United States and/or other countries.) For example, TPS process 10 may determine that an individual frequently reads social network posts by a small set of individuals associated with a trip destination and therefore may desire to meet with those individuals while at the trip destination.

Continuing the examples above, it will be understood that certain past behaviors may sometimes more strongly indicate contacts with whom an individual would like to meet than other past behaviors. For example, for some individuals, frequent online communication with certain contacts through social networking (or activities such as reading posts by those contacts) may indicate that the individual is an “online” friend of those contacts. In some circumstances, however, “online” friendship may not indicate a strong desire to meet a contact during a trip. Accordingly, in some embodiments, social media activity may be combined with analysis of more traditional communication means (e.g., telephone calls, emails, and so on) in order to identify 202 an appropriate set of contacts with whom meetings may be desired. For example, TPS process 10 may determine that although an individual has diligently followed, via social media, a set of thirty contacts associated with a trip destination, the individual has directly called and/or emailed only five of those thirty contacts. Accordingly, TPS process 10 may identify 202 those five contacts as contacts with whom a meeting is more likely to be desired.

The various operations of TPS process 10 may be based upon, for example, past behavior indicating which contacts an individual tends to meet with when visiting a particular destination. For example, TPS process may determine if an individual has previously scheduled multiple appointments with certain contacts associated with a trip destination, has “checked-in” as being with certain contacts (or near-simultaneously with certain contacts) via social media or other applications, has communicated by electronic messages (e.g., email, text messages, instant messaging, and so on) regarding meeting with certain contacts, has explicitly informed certain contacts of the trip (e.g., via email, text message, instant messaging, and so on). Based upon, at least in part, this information, TPS process may accordingly identify 202 a particular set of contacts, or other information associated with a suggested calendar appointment.

TPS process 10 may also, for example, identify 204 a meeting location or 210 a free time slot based on, at least in part, past behavior. For example, analysis of past behavior (as also discussed above) may indicate that an individual, when in Boston, tends to be around the North End on Saturday afternoons, but near Fenway on Friday evenings and that the last eight times an individual visited New York she visited both a particular pizza restaurant and particular store. Accordingly, TPS process 10 may identify 204, 210 a meeting location near the North End for Saturday afternoons in Boston and near Fenway on Friday evenings, and may identify 204 the particular pizza restaurant and particular store for possible meeting locations in New York. In another embodiment, TPS process 10 may identify, from past behavior, a certain amount of time as necessary for travel between two locations—e.g., the North End and Fenway. Accordingly, if, for example, the North End is identified as a current location 302 and Fenway is identified 204 as a meeting location, TPS process 10 may identify 210 a free time slot based on the necessary travel time between the North End and Fenway.

One or more of TPS process 10 operations 200, 202, 204, and 210 may also be based upon, at least in part, current location/status information 302. In some embodiments, current location information 302 may be determined based on information from a on a variety of sources. For example, a location service application can provide current location information 302 as can an application such as the Foursquare® service, Google Latitude, or the like. (Foursquare® is a registered trademark of Foursquare Labs, Inc. in the United States and/or other countries; Google Latitude is a trademark of Google, Inc., in the United States and/or other countries.)

TPS process 10 may, for example, determine 200 a trip destination based on, at least in part, current location/status information 302. For example, a home location for an individual may be San Francisco (as determined, for example, from analysis of past behavior, profile information, and so on) and the individual may check-in via various applications including social network applications as being currently located in New York City. Accordingly, TPS process 10 may determine 200, for that individual, that the trip destination is New York City. In another embodiment, an individual may use social media, electronic messages or other communication means to provide messages, posts of status or other information including indicative language such as “on a business-trip to NY,” “on vacation in Mexico City,” “working in Mumbai,” an so on. Analysis (e.g., contextual analysis) of this information may also indicate that the individual is traveling away from home and thereby provide information related to determining 200 a trip destination.

In another embodiment, identifying 202 contacts may be based on, at least in part, current location information 302. For example, TPS process 10 may provide 212 suggested calendar appointments only with contacts who are themselves located (or will be located at the time of the appointment) at or near the trip destination or meeting location. Accordingly, TPS process 10 may analyze (or otherwise receive) information associated with the current location of contacts (e.g., a contact checking-in at or near the trip destination, whether or not the home location of contact is at or near the trip destination) in order to identify 202 an appropriate set of contacts.

In another embodiment, current status information 302 may be useful to identifying 202 a set of contacts. For example, if a contact provides a status via a social networking service that indicates that the individual is “working,” “busy,” “in a meeting” and so on, TPS process 10 may determine that this contact is not currently available for a meeting with the individual. Alternatively, the status of the contact may indicate that the contact is “free,” “on vacation in Augusta,” and so on, in which case TPS process 10 may determine that this contact is currently available for a meeting with the individual.

In another embodiment, TPS process 10 may identify 204 a possible meeting location based on current location/status information 302. For example, TPS process 10 may identify 204 a location that is near the current location of an individual or a contact as an appropriate location for a meeting between the individual and the contact.

In another embodiment, a free time slot may be identified 210 based on, at least in part, current location/status information 302. For example, if a current location of an individual or a contact is located a large distance from meeting location (and, for example, not close to a rapid transportation option) TPS process 10 may identify 210 a free time slot for a proposed meeting that takes into account the necessary travel time between the current location and the identified 204 meeting location.

One or more of TPS process 10 operations 200, 202, 204, and 210 may also be based upon, at least in part, explicit preference information 304. For example, an individual or a contact may provide to TPS process 10 or to a different application from which TPS process 10 may access information directly or indirectly: user settings that specify a home location; preferences relating to sets of particular contacts with whom meetings may be desired (both generally and/or for a particular trip); preferences relating to meeting locations (e.g., favorite restaurants, parks, and so on), which may be linked to or independent of particular contacts (e.g., a favorite restaurant to visit with a romantic interest versus a favorite restaurant to visit with a business associate); preferences related to free time slots, which may be linked to or independent of particular contacts (e.g., a preference to meet business associates before 5 PM), preferences relating to meeting locations (e.g., a preference not to meet in Central Park after midnight); preferences relating to trip destinations (e.g., a preference not to meet after 10 PM for the first two days of a trip to London, due to expected jet lag effects), and so on.

TPS process 10 may analyze (or otherwise receive) explicit preference information 304 (i.e., information associated with preferences of individuals and relevant contacts) in order to recommend a meeting location, time, set of contacts that may be desirable to all invitees to the meeting, and so on. For example, TPS process 10 may determine an intersection of preferences for meeting locations and times for an individual and a set of contacts in order to identify 204 a meeting location and identify 210 a free time slot that will be desirable for the individual and the set of contacts. (It will be understood that such analysis, and other analyses described herein, may also be applied to other types of information such as current location/status information 302, past behavior information 300, and so on.)

One or more of TPS process 10 operations 200, 202, 204, and 210 may also be based upon, at least in part, social network groupings or other social network information 306. Social network groupings may refer to association of certain contacts in labeled categories within a social networking application. For example, using some social networking application, users can designate specific contacts as belonging to one or more groups thereby categorizing social network contacts into specific categories or groupings. Other social network information may include contacts that an individual follows, contacts frequently communicated with or viewed, and various other information associated with a social networking account or activity.

In certain embodiments, social network groupings and other information 306 may indicate location information. For example, a social network group labeled “neighbors” may provide information related to the home location of an individual and thereby assist, in conjunction with, for example, current location/status information 302, in determining when an individual is on a trip and determining 200 the trip destination.

An individual may also include various contacts in social network groupings with common names like “Family,” “Close Friends,” “Co-Workers,” and so on, or other names that may allow determination of the nature of the relationship between the individual and the contacts. Analysis of these grouping names may accordingly indicate a particular set of contacts with whom a meeting may be desired. For example, on a business trip, TPS process 10 may identify 202 the set of contacts designated as “co-workers” as appropriate contacts for potential meetings (which group may be further refined as described throughout this disclosure—e.g., by location information). Similarly, TPS process 10 may identify 202 the set of contacts designated as “family” or “close friends” as a set of contacts with whom a meeting may be strongly desired whenever the individual travels to a destination that is close to the location of those contacts.

Social network groupings or other information 306 may also be useful to indicate meeting locations. For example, TPS process 10 may determine that for an individual and contacts who belong to or are following a group called “Civil War Re-enactors” might view the Gettysburg battlefield or a Civil War Museum as a desirable meeting place. Similarly, TPS process 10 may determine that individuals and contacts belonging to or are following a group called “Deep-Dish Pizza Fanatics” might prefer a dinner meeting at a particular type of restaurant.

One or more of TPS process 10 operations 200, 202, 204, and 210 may also be based upon, at least in part, contact information 308. For example, contact information associated with an LDAP record, social networking or other online profile, or other accounts or profiles may include explicit designations of home and/or work information for individual or contacts. TPS process 10 may accordingly determine, based on this contact information (alone or in conjunction with other information), that a current or planned location is a trip destination, that a particular contact resides in or near that location, and so on. Similarly, explicit designations of home or work information for a contact may indicate the contact lives or works near a particular neighborhood, restaurant, museum, at or near the trip destination or that the contact lives or works near a particular transit option (e.g., a subway line) that permits easy access to a particular neighborhood, restaurant, museum, and so on. As also described above, such location-related information may be utilized by TPS process 10 to identifying 200 a trip destination, 202 a set of contacts, 204 a meeting location, 210 a free time slot, and so on.

One or more of TPS process 10 operations 200, 202, 204, and 210 may also be based upon, at least in part, calendar information 310. For example, a calendar entry listing flight times to a particular city may indicate that an individual is planning (or is on) a trip to that city. Accordingly, TPS process 10 may determine 200 that the city in the calendar entry is a trip destination. Similarly, calendar entries showing past meetings with various contacts may indicate a preference to meet with those contacts when possible. Accordingly, TPS process 10 may identify 202 those particular contacts for a meeting during a current (or planned) trip. It will be understood that calendar entries for future events, as well as calendar entries for past events, may provide useful information for TPS process 10.

In another embodiment, TPS process 10 may determine that meeting has already been partially scheduled and may provide 212 suggestions containing only partial meeting information. For example, an individual may sometimes schedule a “placeholder” meeting, which may designate, for example, one or more contacts and a time slot, but not a meeting location. With respect to such a placeholder meeting, TPS process 10 may, for example, identify 202 the contacts and identify 210 the time slot based on the placeholder calendar entry and then augment the placeholder meeting calendar entry by identifying 204 a suggested location for the meeting (e.g., by one or more of the many methods described above). For example, based on, at least in part, analysis of past behavior information 300, current location/status information 302, and social network groupings/information 306, TPS process 10 may determine that among a particular set of contacts with whom the individual likely desires to meet, a particular sub-set of contacts are available for the placeholder meeting time. Further TPS process 10 may identify 204 a restaurant that may be enjoyed by both the individual and the sub-set of contacts and that is nearby a subway line accessible by all of the proposed invitees. Accordingly, TPS process may suggest 212 that restaurant as a location for the placeholder meeting.

In another embodiment, a placeholder meeting may indicate a preferred location and time (e.g., a desire visit a particular restaurant for a late dinner while in Tokyo) but may not include a full set of contacts to attend the meeting. Accordingly, TPS process 10 may identify 202 contacts to add to the placeholder meeting (e.g., by one or more of the many methods described above). For example, based on explicit preference information 304 and past behavior information 300, TPS process 10 may identify 202 a set of contacts that are close friends of the individual and who also enjoy the particular restaurant. Accordingly, TPS process 10 may suggest 212 adding these identified contacts to the placeholder meeting.

Continuing the example, above, in another embodiment, TPS process 10 may further suggest 212 adjustments to such a placeholder meeting, based on identifying 202 contacts, in order to, for example, ensure that each of the contacts are able to attend the meeting. For example, based on calendar/other information 310, TPS process 10 may identify 210 the only free time slot for one of the identified 202 close friends of the individual does not coincide with the proposed time for the placeholder meeting. Accordingly, TPS process 10 may suggest 212 a different time slot for the placeholder meeting in order to facilitate attendance of the close friend.

It will be understood that a variety of other types of information may also be utilized by the various operations of TPS process 12. For example, TPS process 12 may analyze the content and/or context of messages like email, text messages, internet-based chat, and so on in order to determine 200 a trip destination, identify 202 sets of contacts, identify 204 locations, identify 210 free time slots, and so on.

With respect to all aspects of TPS process 10, protections of the privacy of individuals and contacts may also be included in the various operations of the process. For example, access of TPS process 10 and/or an individual or a contact to past behavior information 300, current location/status information 302, calendar/other information 310, and so on may be limited based on access rights granted to the individual or the contacts. In some embodiments, TPS process 10 may have access to certain information (e.g., past behavior information 300, explicit preference information 304, and so on) but may not be permitted to provide this information explicitly to an individual and/or a contact. For example, TPS process 10 may analyze the intersection of sets of meeting location (or other) preferences in order to identify 204 a meeting location or 202 set of contacts, but may not explicitly provide information to an individual (or the contacts) relating to why the particular meeting location, set of contacts, and so on was selected. It will be understood that restrictions on access to information may be based upon, for example, on access/privacy permissions associated with the individual and/or a contact. For example, certain contacts may make contact information 308 and social network groupings/information 306 available to an individual by way of personal privacy settings, in which case TPS process 10 may not restrict access of the individual to such information.

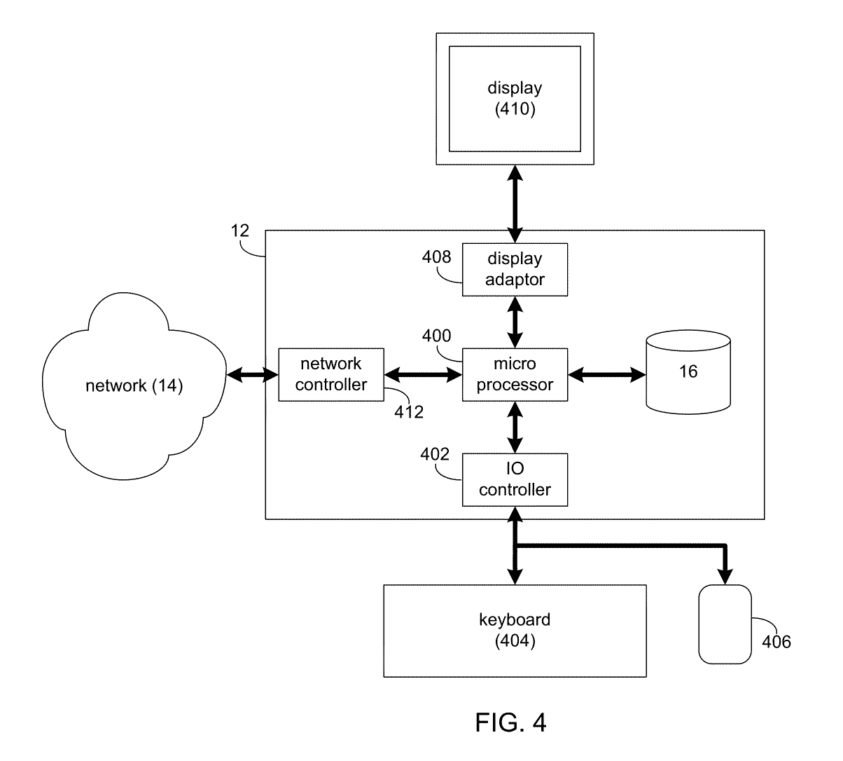

Referring also to FIG. 4, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, TPS process 10 may be substituted for computing device 12 within FIG. 4, examples of which may include but are not limited to client electronic devices 38, 40, 42, 44.

Computing system 12 may include microprocessor 400 configured to e.g., process data and execute instructions/code for TPS process 10. Microprocessor 400 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. 10 controller 402 may be configured to couple microprocessor 400 with various devices, such as keyboard 404, mouse 406, USB ports (not shown), and printer ports (not shown). Display adaptor 408 may be configured to couple display 410 (e.g., a CRT or LCD monitor) with microprocessor 400, while network adapter 412 (e.g., an Ethernet adapter) may be configured to couple microprocessor 400 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, C#.NET, PHP, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 400) of a general purpose computer/special purpose computer/other programmable data processing apparatus (e.g., computing device 12), such that the instructions, which execute via the processor (e.g., processor 400) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments herein are chosen and described in order to best explain the principles of the disclosure and the practical application, and to enable others of ordinary skill in the art to understand the disclosure for various embodiments with various modifications as are suited to the particular uses contemplated.

What is claimed is:

1. A computer-implemented method comprising:
determining, by one or more computing devices, a trip destination for an individual;
identifying, by the one or more computing devices, a set of contacts associated with the individual and the trip destination;
identifying, by the one or more computing devices, a meeting location associated with the trip destination and one or more of the individual and a member of the set of contacts;
identifying, by the one or more computing devices, a free time slot associated with one or more of the individual and a member of the set of contacts; and
providing, by the one or more computing devices, a suggested calendar appointment associated with the individual, the free time slot, the location, and one or more members of the set of contacts.

2. The computer-implemented method of claim 1, further including determining that the individual is taking a trip based upon, at least in part, comparing information associated with one or more of a current location and a planned location of the individual with information associated with a home location of the individual.

3. The computer-implemented method of claim 2, wherein determining one or more of a current location, a planned location, and a home location includes analyzing one or more of social network information, application information, historical location information, check-in information, calendar information, and message content information.

4. The computer-implemented method of claim 1, wherein identifying one or more of the set of contacts and a member of the set of contacts includes analyzing one or more of social network information, application information, calendar information, messaging information, and check-in information.

5. The computer-implemented method of claim 1, wherein identifying the meeting location includes determining a set of preferred locations based on analysis of one or more of past behavior, social network information, message information, calendar information, user input information, current location information, profile information, and check-in information.

6. The computer-implemented method of claim 1, wherein identifying the meeting location is based upon, at least in part, information associated with one or more of the individual and the member of the set of contacts.

7. The computer-implemented method of claim 1, wherein identifying the free time slot includes analyzing calendar information.

8. A computer program product residing on a computer readable medium having a plurality of instructions stored thereon, which, when executed by a processor, cause the processor to perform operations comprising:
determining a trip destination for an individual;
identifying a set of contacts associated with the individual and the trip destination;
identifying a meeting location associated with the trip destination and one or more of the individual and a member of the set of contacts;
identifying a free time slot associated with one or more of the individual and a member of the set of contacts; and
providing a suggested calendar appointment associated with the individual, the free time slot, the location, and one or more members of the set of contacts.

9. The computer program product of claim 8, further including instructions for determining that the individual is taking a trip based upon, at least in part, comparing information associated with one or more of a current location and a planned location of the individual with information associated with a home location of the individual.

10. The computer program product of claim 9, wherein the instructions for determining one or more of a current location, a planned location, and a home location include instructions for analyzing one or more of social network information, application information, historical location information, check-in information, calendar information, and message content information.

11. The computer program product of claim 8, wherein the instructions for identifying one or more of the set of contacts and a member of the set of contacts include instructions for analyzing one or more of social network information, application information, calendar information, messaging information, and check-in information.

12. The computer program product of claim 8, wherein the instructions for identifying the meeting location include instructions for determining a set of preferred locations based on analysis of one or more of past behavior, social network information, message information, calendar information, user input information, current location information, profile information, and check-in information.

13. The computer program product of claim 8, wherein identifying the meeting location is based upon, at least in part, information associated with one or more of the individual and the member of the set of contacts.

14. The computer program product of claim 8, wherein the instructions for identifying the free time slot include instructions for analyzing calendar information.

15. A computing system comprising:
one or more processors and one or more memory modules coupled with the one or more processors, the one or more processors configured for:
determining a trip destination for an individual;
identifying a set of contacts associated with the individual and the trip destination;
identifying a meeting location associated with the trip destination and one or more of the individual and a member of the set of contacts;
identifying a free time slot associated with one or more of the individual and a member of the set of contacts; and
providing a suggested calendar appointment associated with the individual, the free time slot, the location, and one or more members of the set of contacts.

16. The computing system of claim 15, wherein the one or more processors are further configured for determining that the individual is taking a trip based upon, at least in part, comparing information associated with one or more of a current location and a planned location of the individual with information associated with a home location of the individual.

17. The computing system of claim 16, wherein the one or more processors configured for determining one or more of a current location, a planned location, and a home location are further configured for analyzing one or more of social network information, application information, historical location information, check-in information, calendar information, and message content information.

18. The computing system of claim 15, wherein the one or more processors configured for identifying one or more of the set of contacts and a member of the set of contacts are further configured for analyzing one or more of social network information, application information, calendar information, messaging information, and check-in information.

19. The computing system of claim 15, wherein the one or more processor configured for identifying the meeting location are further configured for determining a set of preferred locations based on analysis of one or more of past behavior, social network information, message information, calendar information, user input information, current location information, profile information, and check-in information.

20. The computing system of claim 15, wherein the one or more processors are configured for identifying the meeting location is based upon, at least in part, information associated with one or more of the individual and the member of the set of contacts.

21. The computing system of claim 15, wherein the one or more processors are configured for identifying the free time slot include instructions for analyzing calendar information.
